(19) United States
(12) Patent Application Publication
(10) Pub. No.: US 2026/0094964 A1
(43) Pub. Date: Apr. 2, 2026

(54) BEAMFORMING CONTROL METHOD AND SYSTEM USING PARALLEL SELECTION AND IC ADDRESS

(71) Applicant: Korea Electronics Technology Institute, Seongnam-si (KR)

(72) Inventors: Seung Goo NAM, Suwon-si (KR); Se Hwan CHOI, Seongnam-si (KR); Seok Yeon HONG, Seoul (KR)

(73) Assignee: Korea Electronics Technology Institute, Seongnam-si (KR)

(21) Appl. No.: 19/319,202

(22) Filed: Sep. 4, 2025

(30) Foreign Application Priority Data
Oct. 2, 2024 (KR) 10-2024-0133492

(51) Int. Cl. H01Q 3/36; H01Q 3/28

(52) U.S. Cl. CPC H01Q 3/36; H01Q 3/28

(57) ABSTRACT

Provided is a beamforming control method and system using parallel selection and IC addresses. A beamforming control system according to an embodiment includes: a plurality of beamforming modules provided with a plurality of beamforming ICs, respectively; and a controller configured to select one of the beamforming modules and to select and control one of the beamforming ICs of the selected beamforming module. Accordingly, complexity in designing and manufacturing cost may not increase, and it may be easy to detect data loss in the middle and individually check performance of beamforming ICs, and debugging may be facilitated, and the occurrence of a delay may be prevented through parallel control of all beamforming ICs, so that high-speed beamforming control is enabled.

### CROSS-REFERENCE TO RELATED APPLICATIONS AND CLAIM OF PRIORITY

This application is based on and claims priority under 35 U.S.C. § 119 to Korean Patent Application No. 10-2024-0133492, filed on October 2, 2024, in the Korean Intellectual Property Office, the disclosure of which is herein incorporated by reference in its entirety.

### BACKGROUND

### FIELD

The disclosure relates to a beamforming control technology, and more particularly, to a method for independently/individually selecting and controlling beamforming modules in a tile structure constituting a beamforming system, and beamforming integrated circuits (ICs) provided in each module.

### DESCRIPTION OF RELATED ART

FIG. 1 is a view illustrating a configuration of a related-art beamforming control system. As shown in FIG. 1, the related-art beamforming control system may use a serial peripheral interface (SPI) to connect SPI slaves functioning as beamforming ICs to a SPI master functioning as a micro control unit (MCU) in a daisy chain method, and to control them.

However, the related-art method may require a large number of MCUs, which increases complexity in designing and manufacturing cost, and multiple connections in the daisy chain method may make it difficult to detect data loss and performance of individual beamforming ICs in the middle, and beamforming ICs existing at the final end may have delays in operation, and hence, may require timing control.

### SUMMARY

The disclosure has been developed in order to solve the above-described problems, and an object of the disclosure is to provide a method and a system for controlling beamforming using parallel selection and IC addresses, as a solution to prevent an increase in complexity of designing and manufacturing cost, to facilitate data loss detection and debugging in the middle, and to prevent delays in all beamforming ICs.

According to an embodiment of the disclosure to achieve the above-described object, a beamforming control system may include: a plurality of beamforming modules provided with a plurality of beamforming ICs, respectively; and a controller configured to select one of the beamforming modules and to select and control one of the beamforming ICs of the selected beamforming module.

The controller may output a selection signal to a select pin to which the selected beamforming module is connected, and may select one of the beamforming modules.

The controller may be provided with a plurality of select pins, and the select pins may be individually connected to the beamforming modules, respectively.

The controller may be provided with one clock pin, one output pin, and one input pin, and the clock pin, the output pin, and the input pin may be connected to all the beamforming modules.

The controller may designate an address assigned to the selected beamforming IC in a command, and may select one of the beamforming ICs of the selected beamforming module.

The beamforming modules may be provided with the same number of beamforming ICs, and a system for assigning addresses to the beamforming ICs may be the same for all of the beamforming modules.

Each of the beamforming ICs may be connected to a plurality of antennas.

The controller may detect a loss and check performance while individually controlling the beamforming ICs.

According to another aspect of the disclosure, there is provided a beamforming control method including: selecting, by a controller, one of a plurality of beamforming modules provided with a plurality of beamforming ICs, respectively; selecting, by the controller, one of the beamforming ICs of the selected beamforming module; and controlling, by the controller, the selected beamforming IC.

According to embodiments of the disclosure as described above, beamforming modules may be independently/individually selected through a select pin, and beamforming ICs provided in the selected beamforming module may be independently/individually selected and controlled through address designation. Accordingly, complexity in designing and manufacturing cost may not increase, and it may be easy to detect data loss in the middle and individually check performance of beamforming ICs, and debugging may be facilitated, and the occurrence of a delay may be prevented through parallel control of all beamforming ICs, so that high-speed beamforming control is enabled.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a related-art beamforming control system;

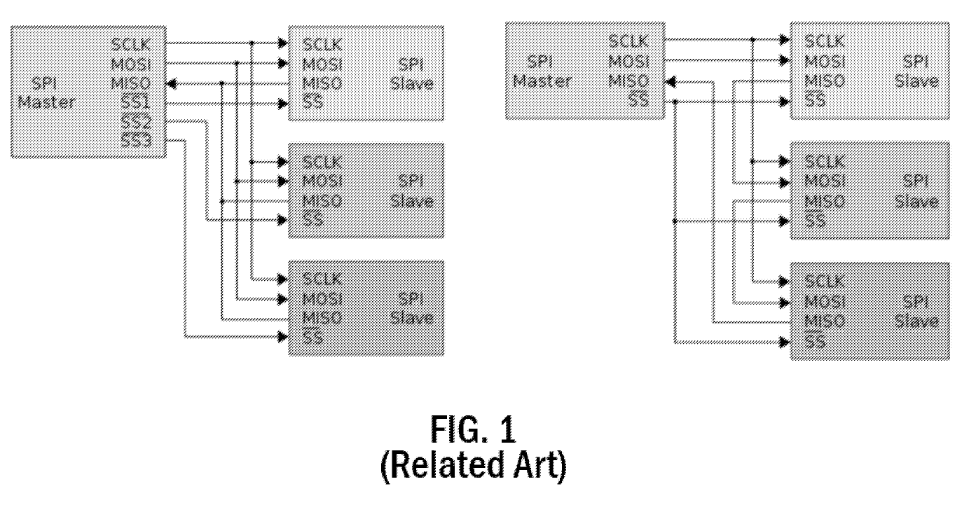

FIG. 2 is a view illustrating a physical structure of a beamforming control system to which the disclosure is applicable;

FIG. 3 is a view illustrating a logical structure for the beamforming control system of FIG. 2;

FIG. 4 is a view illustrating a motherboard layout of a beamforming control system according to an embodiment of the disclosure;

FIG. 5 is a view illustrating pictures of an actual motherboard, and a beamforming module and a patch antenna module mounted; and

FIG. 6 is a view illustrating pictures of an actual beamforming module and an actual patch antenna module.

### DETAILED DESCRIPTION

Hereinafter, the disclosure will be described in more detail with reference to the accompanying drawings.

Embodiments of the disclosure present a beamforming control method and system using parallel selection and IC addresses. The disclosure relates to a technology for independently/individually selecting beamforming modules coupled in a tile structure in a beamforming system, and beamforming ICs provided in each module, and controlling the same.

Specifically, in embodiments of the disclosure, gains and phases of beams are controlled by independently/individually selecting beamforming modules by using a select pin, and independently/individually selecting beamforming ICs provided in the selected beamforming module through address designation.

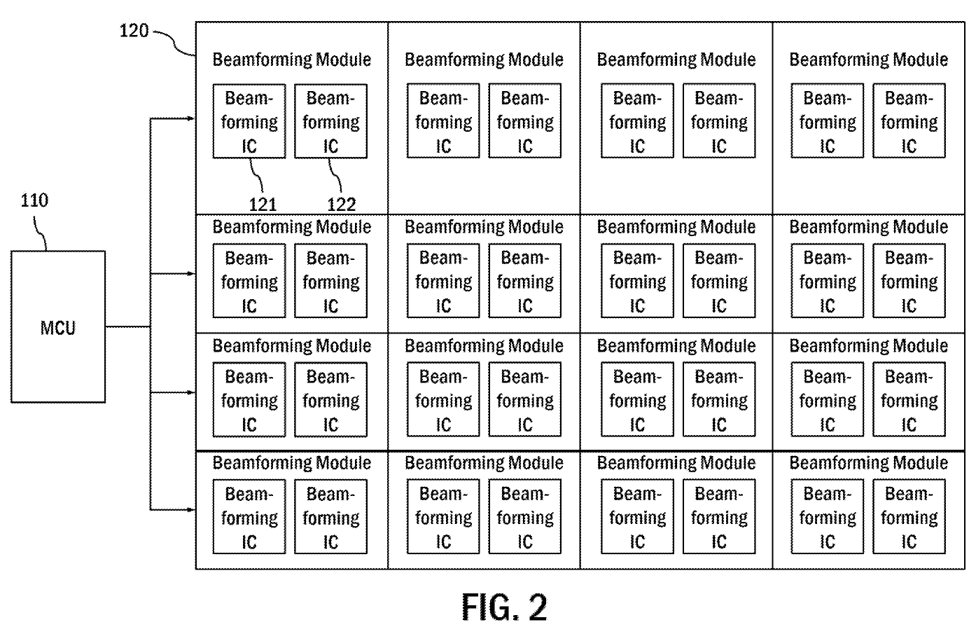

FIG. 2 is a view illustrating a physical structure of a beamforming control system to which the disclosure is applicable. As shown in FIG. 2, the beamforming control system to which the disclosure is applicable may include a micro control unit (MCU) 110 and a plurality of beamforming modules 120 which are arranged in a tile structure.

The beamforming modules 120 may be provided with beamforming ICs 121, 122 which are connected to patch antenna modules (not shown), respectively, to adjust gains and phases of beams exchanged through the patch antenna modules and to adjust directions of beams.

The MCU 110 and the beamforming modules 120 may be communicatively connected through a serial peripheral interface (SPI), such that the MCU 110 serving as a master controls the beamforming ICs 121, 122 provided in the beamforming modules 120 serving as slaves.

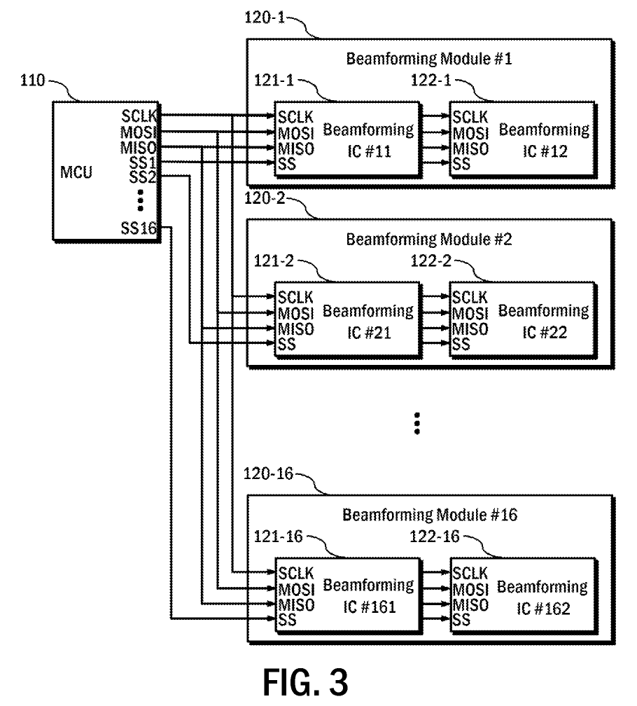

A method of controlling beamforming by the MCU 110 will be described in detail hereinbelow with reference to FIG. 3. FIG. 3 is a view illustrating a logical structure for the beamforming control system shown in FIG. 2, and shows arrangements of components to show a connection relationship between the MCU 110 and the beamforming ICs 121-1, 122-1, 121-2, 122-2, …, 121-16, 122-19 mounted in the beamforming modules 120-1, 120-2, …, 120-16.

As shown in FIG. 3, the MCU 110 may output a clock through a serial Clock (SCLK) pin to supply to all of the beamforming ICs 121-1, 122-1, 121-2, 122-2, …, 121-16, 122-16 of the beamforming modules 120-1, 120-2, …, 120-16.

The MCU 110 may transmit data/commands to the beamforming ICs 121-1, 122-1, 121-2, 122-2, …, 121-16, 122-16 of the beamforming modules 120-1, 120-2, …, 120-16 through a master output slave input (MOSI) pin, and may receive data/responses from the beamforming ICs 121-1, 122-1, 121-2, 122-2, …, 121-16, 122-16 through a master input slave output (MISO) pin.

In addition, the MCU 110 may individually select beamforming modules 120-1, 120-2, …, 120-16 through slave select (SS) pins. For the sake of individual selection, the number of SSs in the MCU 110 may be the same as the number of beamforming modules 120-1, 120-2, …, 120-16, and the SSs may be individually connected with the beamforming ICs 121-1, 122-1, 121-2, 122-2,…, 121-16, 122-16 of the beamforming modules 120-1, 120-2, …, 120-16.

Specifically, 1) SS1 pin of the MCU 110 may be connected with beamforming IC #11121-1 and beamforming IC #12122-1 of beamforming module #1120-1, 2) SS2 pin of the MCU 110 may be connected with beamforming IC #21121-2 and beamforming IC #22122-2 of beamforming module #2120-2, …, 16) SS16 pin of MCU 110 may be connected with beamforming IC #161121-16 and beamforming IC #162122-16 of beamforming module #16120-16.

From this point, the SS pins may differ from the SCLK pin, MOSI pin, MISO pin in that one of each of the SCLK pin, the MOSI pin, and the MISO pin is connected all of the beamforming ICs 121-1, 122-1, 121-2, 122-2, …, 121-16, 122-16.

Two beamforming ICs 121-1, 122-1, 121-2, 122-2, …, 121-16, 122-16 may be provided in each of the beamforming modules 120-1, 120-2, …, 120-16. Accordingly, different IC addresses may be assigned to the beamforming ICs 121-1, 122-1, 121-2, 122-2, …, 121-16, 122-16, such that the MCU 110 is able to individually select and control the beamforming ICs 121-1, 122-1, 121-2, 122-2, …, 121-16, 122-16. Specifically, address #1 0x00 may be assigned to the first beamforming ICs 121-1, 121-2, …, 121-16 of the beamforming modules 120-1, 120-2, …, 120-16, and address #2 0x01 may be assigned to the second beamforming ICs 122-1, 122-2,…, 122-16.

Since the first beamforming ICs 121-1, 121-2, …, 121-16 are included in different beamforming modules 120-1, 120-2, …, 120-16, it may be safe to assign the same IC address, and the same is applied to the second beamforming ICs 122-1, 122-2, …, 122-16. That is, the system for assigning addresses to the beamforming ICs 121-1, 122-1, 121-2, 122-2, …, 121-16, 122-16 may be the same for all of the beamforming modules 120-1, 120-2, …, 120-16.

The MCU 110 may only output a selection signal to one of the SS pins to select one of the beamforming modules 120-1, 120-2, …, 120-16, and may individually select the beamforming ICs 121-1, 122-1, 121-2, 122-2, …, 121-16, 122-16 by designating IC addresses through a command transmitted through the MOSI pin.

For example, when beamforming module #1120-1 is selected by only outputting a selection signal to SS1 pin, 1) address #1 is only designated in a command so that the command is only received at beamforming IC #1121-1, 2) address #2 is only designated in a command, so that the command is only received at beamforming IC #2122-1, 3) both addresses #1, #2 or a broadcast is designated in a command, so that the command is received at both beamforming IC #1121-1 and beamforming IC #2122-1.

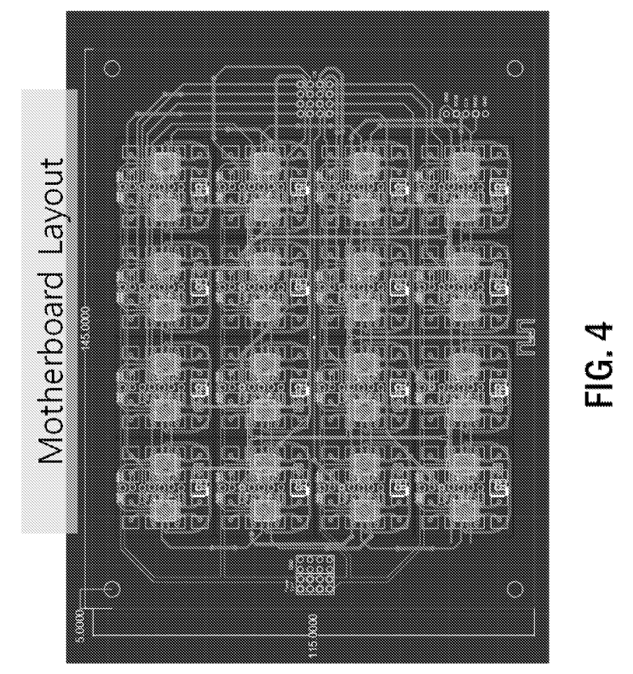

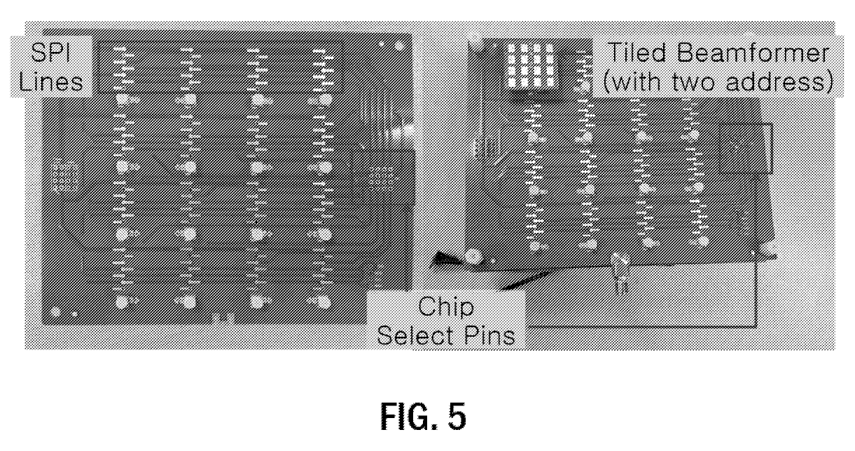

FIG. 4 illustrates a motherboard layout of the beamforming control system according to the above embodiment, and FIG. 5 illustrates a picture (left side) of an actual motherboard, and a picture (right side) of a motherboard on which one beamforming module and one patch antenna module are mounted.

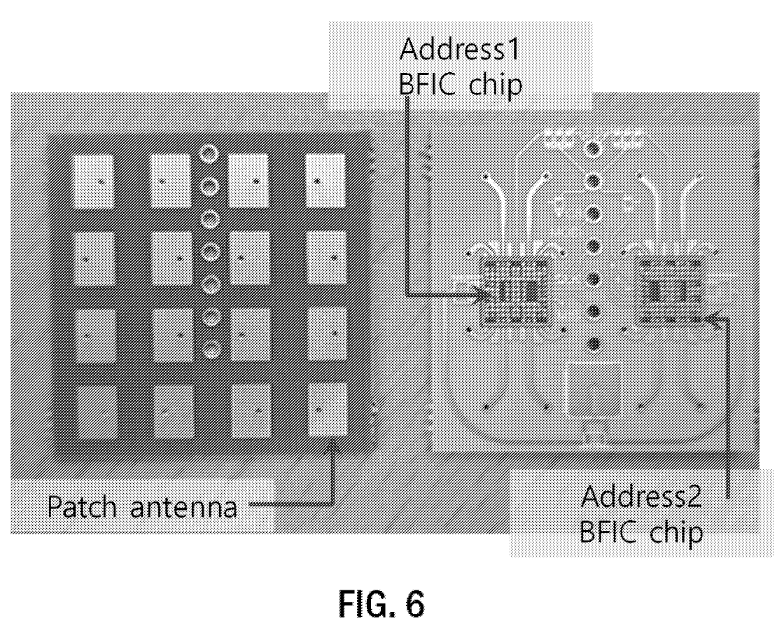

FIG. 6 shows a picture (right side) of an actual beamforming module, and a picture (left side) of a patch antenna module connected to the corresponding beamforming module. As shown in FIG. 6, the beamforming module (right picture) may be provided with two beamforming ICs, and one beamforming module may be connected to 16 patch antennas (left picture). That is, 8 patch antennas may be connected to one beamforming IC.

Up to now, a beamforming control method and system using parallel selection and IC addresses has been described in detail with reference to preferred embodiments.

In the above embodiments, beamforming modules may be independently/individually selected through a select pin, and beamforming ICs provided in the selected beamforming module may be independently/individually selected and controlled through address designation.

Accordingly, one MCU is enabled to control all beamforming ICs, so that increases in complexity in designing and manufacturing cost caused by increase in the number of MCUs may be avoided.

In addition, since it is possible to individually select and operate beamforming ICs, data loss may be detected in the middle and individual performance of beamforming ICs may be checked, and accordingly, debugging may be facilitated.

Furthermore, the occurrence of a delay in receiving commands, which is a problem in the daisy chain method, may be prevented through parallel control of all beamforming ICs, so that high-speed beamforming control is enabled.

Although 16 beamforming modules are illustrated in the above embodiment, the number of beamforming modules is not limited to 16 and the technical idea of the disclosure may be applied to the other cases.

Furthermore, it is assumed that two beamforming ICs are provided in one beamforming module, but this is merely an example for the convenience of explanation, and three or more beamforming ICs may be provided in one beamforming module.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A beamforming control system comprising:
a plurality of beamforming modules provided with a plurality of beamforming ICs, respectively; and
a controller configured to select one of the beamforming modules and to select and control one of the beamforming ICs of the selected beamforming module.

2. The beamforming control system of claim 1, wherein the controller is configured to output a selection signal to a select pin to which the selected beamforming module is connected, and to select one of the beamforming modules.

3. The beamforming control system of claim 2, wherein the controller is provided with a plurality of select pins, and
wherein the select pins are individually connected to the beamforming modules, respectively.

4. The beamforming control system of claim 3, wherein the controller is provided with one clock pin, one output pin, and one input pin, and
wherein the clock pin, the output pin, and the input pin are connected to all the beamforming modules.

5. The beamforming control system of claim 3, wherein the controller is configured to designate an address assigned to the selected beamforming IC in a command, and to select one of the beamforming ICs of the selected beamforming module.

6. The beamforming control system of claim 5, wherein the beamforming modules are provided with the same number of beamforming ICs, and a system for assigning addresses to the beamforming ICs is the same for all of the beamforming modules.

7. The beamforming control system of claim 1, wherein each of the beamforming ICs is connected to a plurality of antennas.

8. The beamforming control system of claim 1, wherein the controller is configured to detect a loss and check performance while individually controlling the beamforming ICs.

9. A beamforming control method comprising:
selecting, by a controller, one of a plurality of beamforming modules provided with a plurality of beamforming ICs, respectively;
selecting, by the controller, one of the beamforming ICs of the selected beamforming module; and
controlling, by the controller, the selected beamforming IC.
